(19) United States
(12) Patent Application Publication
(10) Pub. No.: US 2018/0199031 A1
(43) Pub. Date: Jul. 12, 2018

(54) VIDEO ENCODING APPARATUS AND VIDEO DATA AMOUNT ENCODING METHOD

(71) Applicant: MStar Semiconductor, Inc., Hsinchu Hsien (TW)

(72) Inventor: He-Yuan LIN, Hsinchu Hsien (TW)

(21) Appl. No.: 15/794,253

(22) Filed: Oct. 26, 2017

(30) Foreign Application Priority Data
Jan. 9, 2017 (TW) 106100619

(51) Int. Cl. H04N 19/105; H04N 19/625; H04N 19/146

(52) U.S. Cl. CPC H04N 19/105; H04N 19/567; H04N 19/146; H04N 19/625

(57) ABSTRACT

A video encoding apparatus is provided. A controller in the video encoding apparatus includes a sum calculating circuit, a data amount estimating circuit, and an evaluating circuit. Each of a plurality of intra-prediction and motion compensation modes corresponds to a set of transformed/quantized residual data. The sum calculating circuit calculates, for each set of transformed/quantized residual data, a sum of absolute values of non-zero elements therein and a sum of coordinate values of these non-zero elements relative to a reference point. The data amount estimating circuit generates, for each intra-prediction and motion compensation mode, an estimated data amount according to the sum of absolute values and the sum of absolute values of the coordinate values of corresponding transformed and quantized residual data. The evaluating circuit selects a best mode from the plurality of intra-prediction and motion compensation modes according to the plurality of estimated data amounts.

This application claims the benefit of Taiwan application Serial No. 106100619, filed Jan. 9, 2017, the subject matter of which is incorporated herein by reference.

### BACKGROUND OF THE INVENTION

### Field of the Invention

The invention relates in general to an image processing technology, and more particularly, to a technology that selects a best mode from multiple image processing modes according to a data amount.

### Description of the Related Art

With the thriving development of various electronics-related technologies in the recent years, multimedia systems such as home theaters have become popular. In most multimedia systems, one of the most critical hardware device is the image display apparatus. To satisfy viewer needs for realistic images, one development trend of image display apparatuses is continually increasing the size and resolution of frames, resulting in a significant increase in the image data amount of each frame. Therefore, while preserving good image quality, how to minimize the image data amount through compression technologies to reduce storage space as well as transmission resources is a topic worthy of attention.

FIG. 1 shows a function block diagram of a video encoding system currently commonly applied. Each frame is usually divided into multiple image blocks each serving as a basic unit for encoding. Reference data of a block to be encoded is inputted to an intra-prediction and motion compensation circuit 101, which outputs a reference block after computing the inputted reference data. The intra-prediction and motion compensation circuit 101 further provides a function of motion estimation, which is however not within the discussion range of the present invention and shall be omitted herein. A residual generating circuit 102 identifies a difference between the block to be encoded and the reference block. The difference between the blocks, usually referred to as residual data, is forwarded to a transform circuit 103A to undergo discrete cosine transform (DCT), and then to a quantization circuit 103B to undergo quantization. Next, an entropy encoding circuit 104 performs entropy encoding on the transformed and quantized residual data and the corresponding metadata to generate an encoding result.

An inverse quantization circuit 106A and an inverse transform circuit 106B simulate the transformed and quantized residual data received by an image decoding terminal, and generate restored residual data. An adding circuit 107 adds the restored residual data and the reference block and stores the result to a buffer 108. The stored result serves as intra-prediction and motion compensation reference data used by the intra-prediction and motion compensation circuit 101.

In practice, there are tens of modes available for the intra-prediction and motion compensation 101 to perform intra-prediction and motion compensation, and these modes lead to different encoding results. One most commonly adopted Lagrange method is capable of estimating an intra-prediction and motion compensation mode that attends to both requirements of low data amount and low distortion. In the video encoding system 100 in FIG. 1, a control circuit 110A controls the intra-prediction and motion compensation circuit 101 to individually attempt various intra-prediction and motion compensation modes. The controller 110 further includes a data amount calculating circuit 1106, a distortion calculating circuit 110C and an estimating circuit 110D. The data amount calculating circuit 1106 calculates a data amount R of an encoding result. The distortion calculating circuit 110C receives the residual data generated by the residual generating circuit 102 and the restored residual data generated by the inverse transform circuit 1066, and accordingly calculates a distortion amount D caused by the transform circuit 103B and the quantization circuit 103B, and provides the calculated distortion amount D to the estimating circuit 110D for reference. The estimating circuit 110D calculates a rating for each intra-prediction and motion compensation mode according to the Lagrange method. In brief, the rating gets lower as the data amount R of the encoding result is lower, and the rating also gets lower as the distortion amount D is lower. Thus, the estimating circuit 110D selects the intra-prediction and motion compensation having the lowest rating as a best mode.

Before the estimating circuit 110D selects the best mode, every entropy encoding result generated by the entropy encoding circuit 104 is temporarily stored in a temporary memory 109. Only when the estimating circuit 110D has selected the best mode, the temporary memory 109 then sends the encoding result (denoted as the best encoding result) corresponding to the best mode as an output signal of the video encoding system 100.

In the video encoding system 100, the method that sequentially calculates the data amount and the distortion amount of the encoding result of each intra-prediction and motion compensation mode, although capable of accurately selecting the best mode, is quite time consuming and involves immense amounts of computation resources.

### SUMMARY OF THE INVENTION

To solve the above issues, the present invention provides a video encoding apparatus and video encoding method.

According to an embodiment of the present invention, a video encoding apparatus includes an intra-prediction and motion compensation circuit, a residual generating circuit, a transform circuit, a quantization circuit and a controller. The intra-prediction and motion compensation circuit adopts a plurality of intra-prediction and motion compensation modes for an image block to be encoded to determine a plurality of reference blocks. The residual generating circuit generates a plurality of sets of corresponding residual data according to the image block to be encoded and the plurality of reference blocks. The transform circuit performs discrete cosine transform (DCT) on each set of residual data to generate a transformed matrix. The quantization circuit performs quantization on each transformed matrix to generate a set of transformed and quantized residual data. The controller includes a sum calculating circuit, a data estimating circuit and an evaluating circuit. The sum calculating circuit calculates, for each set of transformed and quantized residual data, a sum of absolute values of non-zero elements therein and a sum of coordinate values of these non-zero elements relative to a reference point. The data amount estimating circuit generates an estimated data amount according to the sum of the absolute values and the sum of the coordinate values of the corresponding transformed and quantized residual data of each intra-prediction and motion compensation mode. The evaluating circuit selects a best mode from the plurality of intra-prediction and motion compensation modes according to the plurality of estimated data amounts.

According to another embodiment of the present invention, a video encoding method is provided. In the video encoding method, a plurality of intra-prediction and motion compensation modes are adopted for an image bblock to be encoded to determine a plurality of reference blocks. A plurality of sets of corresponding residual data is generated according to the image block to be encoded and the plurality of reference blocks. Discrete cosine transform (DCT) and quantization are performed on each set of residual data to generate a set of transformed and quantized residual data. For each set of transformed and quantized residual data, a sum of absolute values of non-zero elements therein and a sum of coordinate values of these non-elements relative to a reference point are calculated. An estimated data amount is generated according to the sum of the absolute values and the sum of the coordinate values of the corresponding transformed and quantized residual data of each intra-prediction and motion compensation mode. A best mode is selected from the plurality of intra-prediction and motion compensation modes according to the plurality of estimated data amount.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 (prior art) is a function block diagram of a currently commonly applied video encoding system;

FIG. 2 is a function block diagram of a video encoding system according to an embodiment of the present invention;

FIG. 3 is an example of a 4*4 data matrix;

FIG. 4 is a function block diagram of a video encoding system according to another embodiment of the present invention;

FIG. 5 is a function block diagram of a video encoding system according to another embodiment of the present invention;

FIG. 6 is a flowchart of an image processing method according to an embodiment of the present invention; and

FIG. 7 is a flowchart of an image processing method according to another embodiment of the present invention.

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

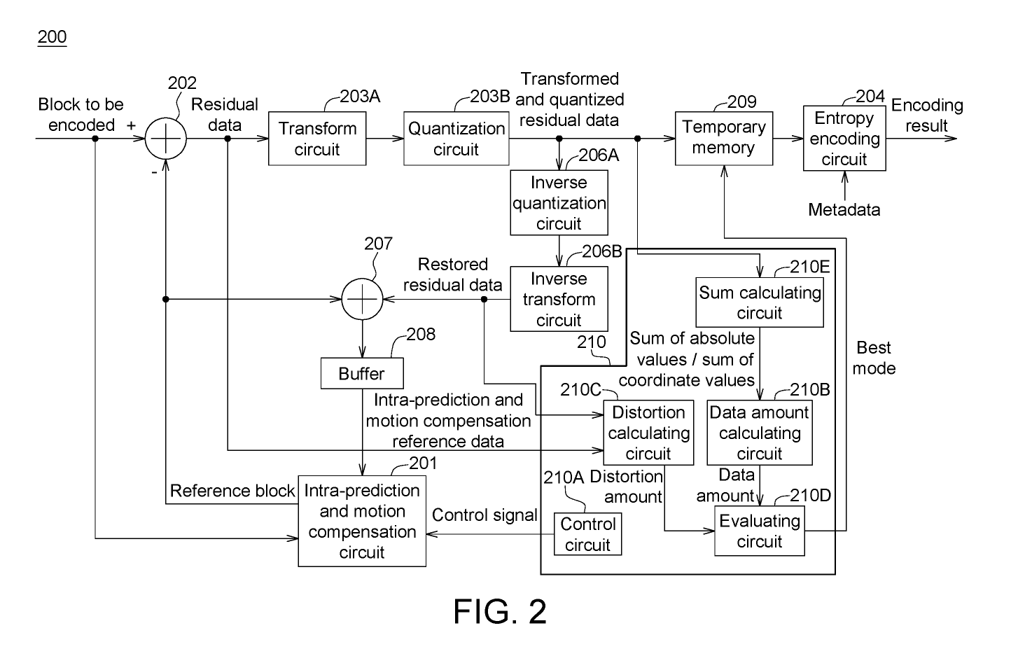

A video encoding system is provided according to an embodiment of the present invention. Referring to the function block diagram in FIG. 2, a video encoding system 200 includes an intra-prediction and motion compensation circuit 201, a residual generating circuit 202, a transform circuit 203A, a quantization circuit 203B, an entropy encoding circuit 204, an inverse quantization circuit 206A, an inverse transform circuit 206B, an adding circuit 107, a buffer 208, a random access memory 209 and a controller 210. The controller 210 includes a control circuit 210A, a data amount estimating circuit 210B, a distortion calculating circuit 210C, an evaluating circuit 210D and a sum calculating circuit 210E.

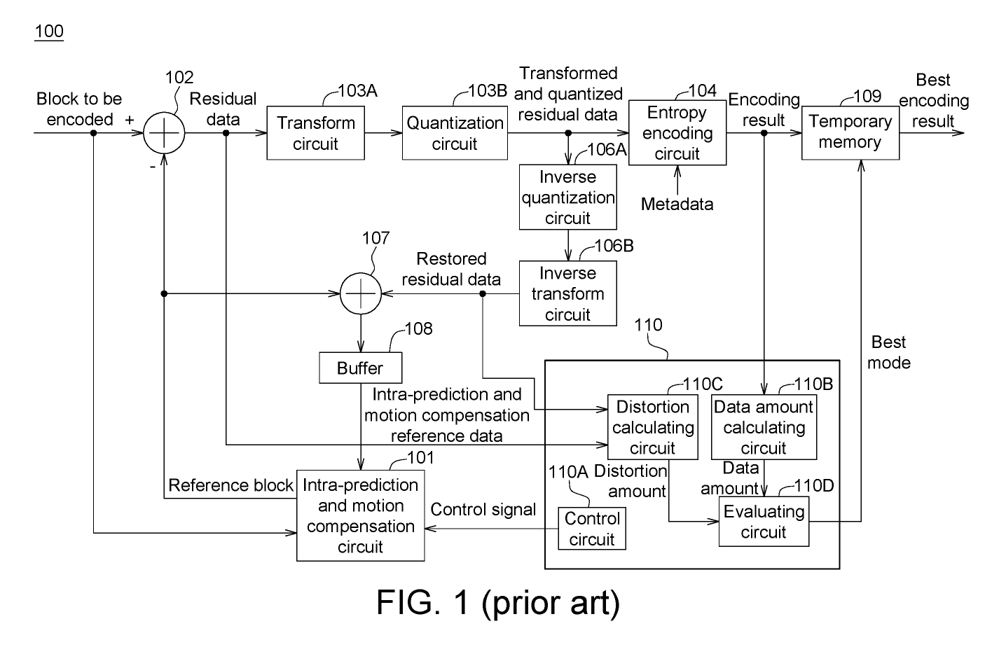

In this embodiment, the intra-prediction and motion compensation circuit 201, the residual generating circuit 202, the transform circuit 203A, the quantization circuit 203B, the inverse quantization circuit 206A, the inverse transform circuit 206B, the adding circuit 207 and the buffer 208 are generally known art, and associated operation details can be referred from the description of the corresponding circuits in FIG. 1. One main difference between the video encoding system 200 and the video encoding system 100 is that, the controller 210, instead of according to the accurate data amount of an encoding result, selects a best mode according to an estimated data amount generated with reference to transformed and quantized residual data. Associated details are given below.

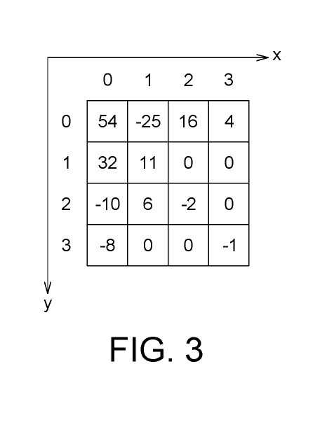

For each intra-prediction and motion compensation mode, the quantization circuit 203B generates a set of transformed and quantized residual data. FIG. 3 shows an example of a 4*4 data matrix, which represents two-dimensional data of the transformed and quantized residual data. In the matrix, each data value has a horizontal coordinate x and a vertical axis y. The sum calculating circuit 210E calculates a sum SUM_{ABS} of absolute values of non-zero elements in the transformed and quantized residual data, and a sum SUM_{CRD} of coordinate values of these non-zero elements relative to a reference point. Taking the data matrix in FIG. 3 for example, the sum SUM_{ABS} of absolute values calculated by the sum calculating circuit 210E is:

54+25+16+4+32+11+10+6+2+8+1=169

In one embodiment, the sum calculating circuit 210E adds the vertical coordinate values and the horizontal coordinate values of all non-zero elements as the sum SUM_{CRD} of coordinate values. Taking the data matrix in FIG. 3 for example, the sum SUM_{CRD} of coordinate values calculated by the sum calculating circuit 210E is:

(0+0)+(1+0)+(2+0)+(3+0)+(0+1)+(1+1)+(0+2)+(1+2)+(2+2)+(0+3)+(3+3)=27

For each intra-prediction and motion compensation mode, the data estimating circuit 210B generates an estimated data amount \hat{R} according to the sum SUM_{ABS} of absolute values and the sum SUM_{CRD} of coordinate values. In one embodiment, the data estimating circuit 210B assigns predetermined weightings to each of the sum SUM_{ABS} of absolute values and the sum SUM_{CRD} of coordinate values respectively, and generates the estimated data amount \hat{R} according to the weighted sum of absolute values and the weighted sum of coordinate values. For example, the data estimating circuit 210B may adopt the following predetermined algorithm:

\hat{R}=a*SUM_{ABS}+b*SUM_{CRD}+c (1)

In equation (1), a, b and c represent constant parameters (the parameters a and b being the above predetermined weights), and may be generated by methods such as linear regression. More specifically, with the assistance of the data amount calculating circuit 1108 in FIG. 1 and multiple sets of sample data, a circuit designer can first determine the relation of the corresponding actual data amount to the sum SUM_{ABS} of absolute values, and to the sum SUM_{CRD} of coordinate values, and thus identify a suitable algorithm (e.g., identifying appropriate parameters a, b and c) by methods such as linear regression to describe such corresponding relation. In other words, the predetermined weightings assigned to the sum SUM_{ABS} of absolute values and the sum SUM_{CRD} of coordinate values may be determined by methods such as linear regression. It should be noted that, the algorithm describing the corresponding relation may include polynomials of the sum SUM_{ABS} of absolute values and the sum SUM_{CRD} of coordinate values, i.e., the algorithm is not limited to including monomials as in equation (1).

In another embodiment, for each set of transformed and quantized residual two-dimensional data, the sum calculating circuit 210E calculates a sum SUM_{CRD}_{_}_{X} of horizontal coordinate values and a sum SUM_{CRD}_{_}_{Y} of vertical coordinate values of the non-zero elements therein. The data amount estimating circuit 210B assigns predetermined weightings for the sum SUM_{ABS} of absolute values, the sum SUM_{CRD}_{_}_{X} of horizontal coordinate values and a sum SUM_{CRD}_{_}_{Y} of vertical coordinate values respectively, and generates the estimated data amount \hat{R} according to the weighted sum of absolute values, the weighted sum of horizontal coordinate values and the weighted sum of vertical coordinate values. For example, the data amount estimating circuit 210B may adopt the predetermined algorithm below:

\hat{R}=a*SUM_{ABS}+b1*SUM_{CRD}_{_{X}}+b2*SUM_{CRD}_{_}_{Y}+c (2)

In equation (2), the parameters a, b1, b2 and c may be generated be approaches such as the foregoing linear regression.

As shown in FIG. 2, the estimated data amount \hat{R} generated by the data amount estimating circuit 210B is provided to the evaluating circuit 210D. For the same image block to be encoded, the control circuit 210A controls the intra-prediction and motion compensation circuit 201 to individually perform various intra-prediction and motion compensation modes, and the data amount estimating circuit 210B subsequently generates different corresponding estimated data amounts \hat{R} corresponding to the various modes.

Similarly, the distortion calculating circuit 210C generates different distortion amounts D correspondingly according to the various intra-prediction and motion compensation modes. More specifically, the inverse quantization circuit 206A and the inverse transform circuit 206B reconstruct the transformed and quantized residual data of the various modes to generate the corresponding restored residual data. The distortion calculating circuit 210C determines the distortion amount D according to a difference between the restored residual data and the residual data generated by the residual generating circuit 202. According to the estimated data amounts \hat{R} and the distortion amounts D of all intra-prediction and motion compensation modes, the evaluating calculating 210D can select, among a plurality of image processing modes of the intra-prediction and motion compensation circuit 20, one best mode (i.e., the mode that most capable of attending to both low data amount and low distortion) for the current image block by the Lagrange method or a similar method.

In one embodiment, before the evaluating circuit 210D selects the best mode, the transformed and quantized data may be temporarily stored in the random access memory 209. When the evaluating circuit 210D has selected the best mode, have the random access memory 209 provide the transformed and quantized residual data corresponding to the best mode to the entropy encoding circuit 204, which then performs entropy encoding on the transformed and quantized residual data and the corresponding metadata to generate an encoding result.

In another embodiment, the random access memory 209 stores only the transformed and quantized residual data of the currently known best mode. Each time the evaluating circuit 210D discovers that another intra-prediction and motion compensation mode is better, the originally stored transformed and quantized data in the random access memory 209 is replaced by the new transformed and quantized residual data. When all of the intra-prediction and compensation modes have been attempted, the transformed and quantized residual data stored in the random access memory 209 is the transformed and quantized residual data corresponding to the best mode. Such approach offers a benefit of saving the hardware space of the memory 209.

In yet another embodiment, before the evaluating circuit 210D selects the best mode, the memory 209 does not store any transformed and quantized residual data, but records (e.g., by an index) only the current best mode. When all of the intra-prediction and motion compensation modes have been attempted, the control circuit 210A controls the intra-prediction and compensation circuit 201, the residual generating circuit 202, the transform circuit 203A and the quantization circuit 203B to again generate the transformed and quantized residual data corresponding to this best mode for the entropy encoding circuit 204 to perform entropy encoding.

It is known from the above description that, in the video encoding system 200, the data amount estimating circuit 210B generates the estimated data amount \hat{R} according to the transformed and quantized residual data. Compared to the prior art in FIG. 1, the entropy encoding circuit 204 only needs to encode the transformed and quantized residual data and the metadata corresponding to the selected best mode but not all of the transformed and quantized residual data and the metadata respectively corresponding the various modes. The video encoding system 200 can generate the estimated data amount \hat{R} by using a shorter period and less computation resources, and the estimated data amount \hat{R} can then be used as reference data for the evaluating circuit 210D to select the best mode.

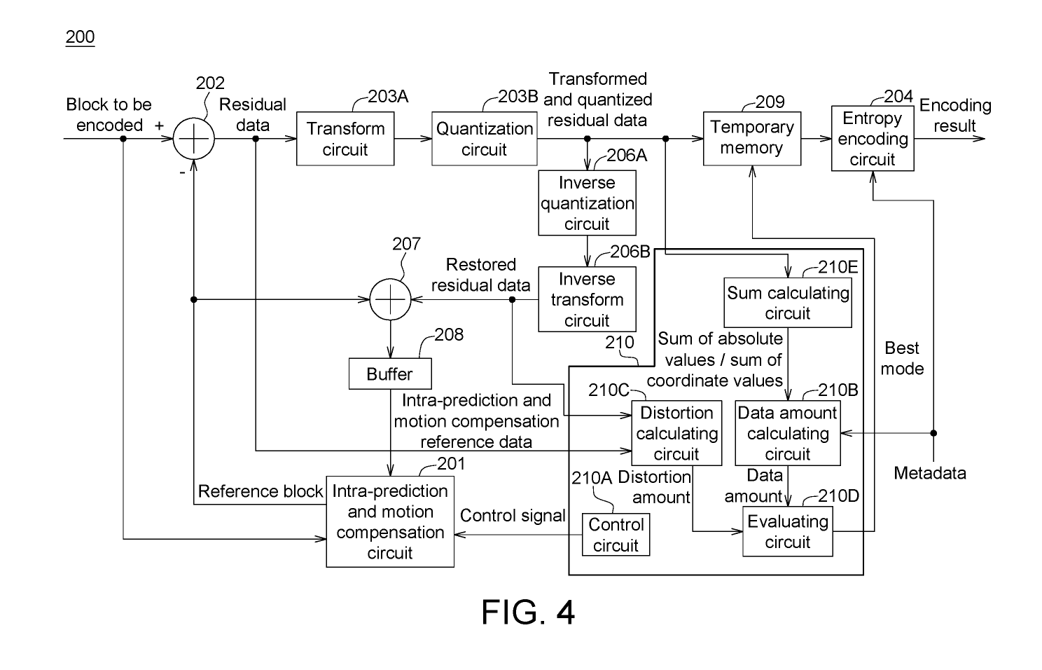

Referring to FIG. 4, in another embodiment, the data amount estimating circuit 210B estimates data amounts of metadata of the various intra-prediction ad motion compensation modes. For example, in the metadata one of the parameters is represented by multiple bits; when a part of the multiple bits is defined as bypass data, it means that this part of bits cannot be correctly predicted through the probability of occurrence, and thus the entropy encoding circuit 204 does not apply entropy encoding on those bits. In every mode, it is known that whether the contents of the parameters in the metadata are bypass data or non-bypass data, and thus the data amount estimating circuit 210B can calculate a bypass data amount B_{P} and a non-bypass data amount B_{NP} of the corresponding metadata according to the above information, and accordingly generate an estimated metadata amount \hat{R}_{META}.

For example, the data amount estimating circuit 210B can adopt the predetermined equation below:

\hat{R}_{META}=B_{P}+α*B_{NP} (3)

In equation (3), the symbol α represents a weighting parameter and it may be determined by experience, e.g., the symbol α may be set to be equal to 1 or slightly smaller than 1. In practice, if the contents in the various metadata are fixed, the data amount estimating circuit 210B can generate the bypass data amount B_{P} and the non-bypass data amount B_{NP} through a look-up table.

In addition to the sum SUM_{ABS} of absolute values and the sum SUM_{CRD} of coordinate values of the various modes, the data amount estimating circuit 210B generates the estimated data amount \hat{R} for each mode further according to the estimated metadata data amount \hat{R}_{META}. For example, the data amount estimating circuit 210B may modify equation (1) to:

\hat{R}=α*SUM_{ABS}+b*SUM_{CRD}+c+R_{META} (4)

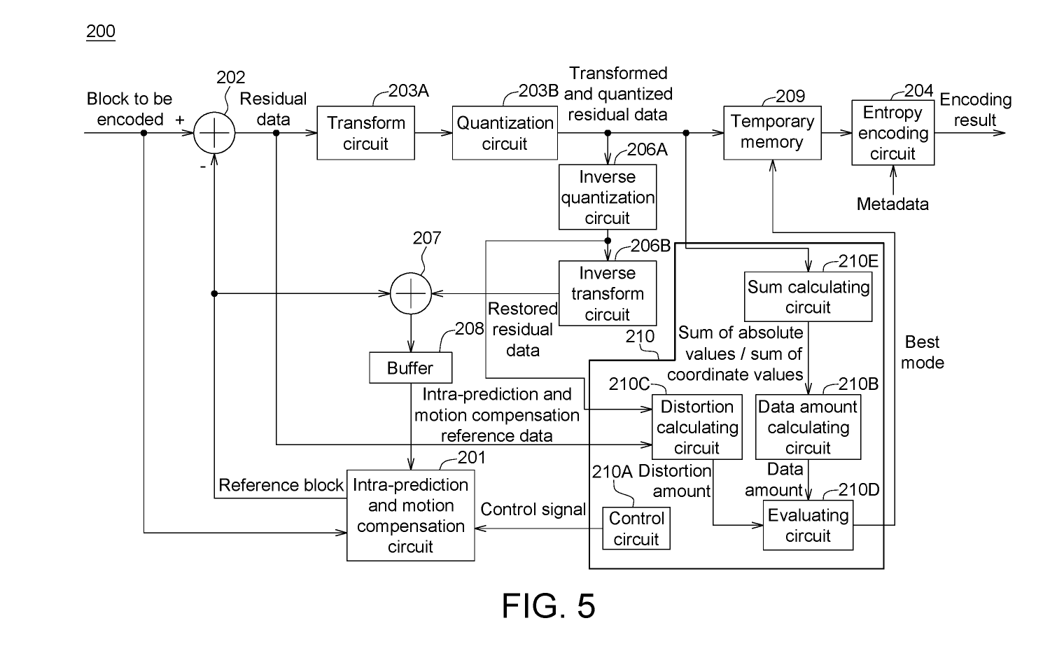

FIG. 5 shows a variation of the video encoding system 200 according to another embodiment. In this embodiment, the distortion calculating circuit 210C is replaced by a distortion estimating circuit 210F. Input signals of the distortion estimating circuit 210F are a transformed matrix generated by the transform circuit 203A and a quantized result generated by the inverse quantization circuit 206A, respectively. For each intra-prediction and motion compensation mode, the distortion estimating circuit 210F calculates a difference between the inverse quantized result and the transformed matrix as an estimated distortion amount \hat{D} as one reference for the evaluating circuit 210D when it selects the best mode. Compared to the prior art in FIG. 1, the approach in FIG. 5 does not involve the inverse transform and thus reduces the computation cost and time needed for generating the estimated distortion amount \hat{D}.

Further, the distortion estimating circuit 210F may calculate a most-significant-bit difference between the transformed matrix and the inverse quantized result while omitting a least-significant-bit difference between the two. For example, assuming each element in the transformed matrix and the inverse quantized result is represented by 16-bit binary data, the distortion estimating circuit 210F may calculate the difference between the eight most significant bits of the two elements and omit the difference between the eight least significant bits. Such approach also achieves effects of further reducing computation cost and time.

In practice, the sum calculating circuit 210E, the data amount estimating circuit 210B and the distortion estimating circuit 210F may each be implemented, for example but not limited to, a fixed and/or programmable digital logic circuit, including a programmable logic gate array, application-specific integrated circuit, microcontroller, microprocessor, digital signal process, and other necessary circuits.

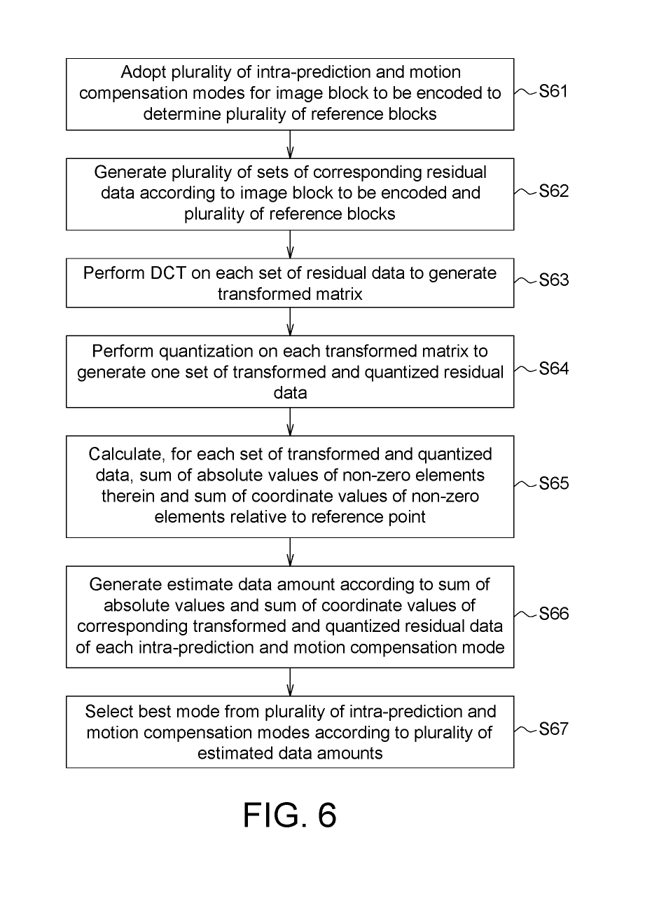

FIG. 6 shows a flowchart of the video encoding method according to another embodiment of the present invention. In step S61, a plurality of intra-prediction and motion compensation modes are adopted for an image block to be encoded to determine a plurality of reference blocks. In step S62, a plurality of sets of corresponding residual data is generated according to the image block to be encoded and the plurality of reference blocks. In step S63, discrete cosine transform (DCT) is performed on each set of residual data to generate a transformed matrix. In step S64, quantization is performed on each transformed matrix to generate a set of transformed and quantized residual data. In step S65, for each set of transformed and quantized residual data, a sum of absolute values of non-zero elements therein and a sum of coordinate values of these non-zero elements relative to a reference point are calculated. In step S66, an estimated data amount is generated according to the sum of the absolute values and the sum of the coordinate values of the corresponding transformed and quantized residual data of each intra-prediction and motion compensation mode. In step S67, a best mode is selected from the plurality of intra-prediction and motion compensation modes according to the plurality of estimated data amounts.

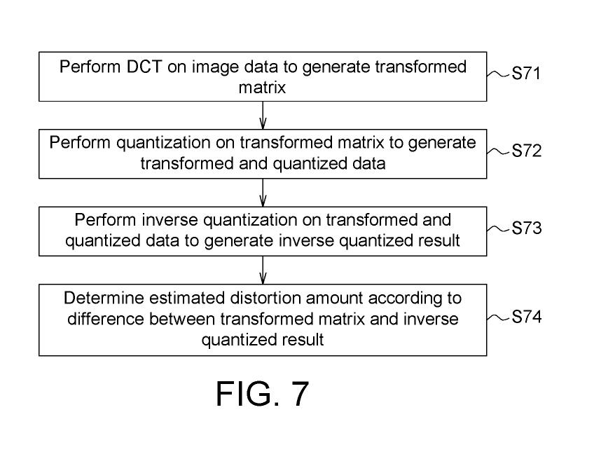

FIG. 7 shows a flowchart of an image processing method according to another embodiment of the present invention. In step S71, discrete cosine transform (DCT) is performed on a set of image data to generate a transformed matrix. In step S72, quantization is performed on the transformed matrix to generate transformed and quantized data. In step S73, inverse quantization is performed on the transformed and quantized data to generate an inverse quantized result. In step S74, an estimated distortion amount is determined according a difference between the transformed matrix and the inverse quantized result.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A video encoding apparatus, comprising:
an intra-prediction and motion compensation circuit, adopting a plurality of intra-prediction and motion compensation modes for an image block to be encoded to determine a plurality of reference blocks;
a residual generating circuit, generating a plurality of sets of residual data according to the image block to be encoded and the plurality of reference blocks;
a transform circuit, performing discrete cosine transform (DCT) on each set of residual data to generate a transformed matrix;
a quantization circuit, performing quantization on each transformed matrix to generate a set of transformed and quantized residual data; and
a controller, comprising:
a sum calculating circuit, calculating, for each set of transformed and quantized residual data, a sum of absolute values of non-zero elements therein and a sum of coordinate values of these non-zero elements relative to a reference point;
a data amount estimating circuit, generating an estimated data amount according to the sum of the absolute values and the sum of the coordinate values of the corresponding transformed and quantized residual data of each intra-prediction and motion compensation mode; and
an evaluating circuit, selecting a best mode from the plurality of intra-prediction and motion compensation modes according to the plurality of estimated data amounts.

2. The video encoding apparatus according to claim 1, wherein, of each transformed and quantized residual data, the data amount estimating circuit respectively assigns predetermined weightings to the sum of the absolute values and the sum of the coordinate values to generate a weighted sum of the absolute values and a weighted sum of the coordinate values to generate the estimated data amount accordingly.

3. The video encoding apparatus according to claim 1, wherein, for each set of transformed and quantized residual data, the sum calculating circuit calculates, a sum of vertical coordinate values and a sum of horizontal coordinate values of the non-zero elements; the data amount estimating circuit assigns predetermined weightings to the sum of the absolute values, the sum of the vertical coordinate values and the sum of the horizontal coordinate values respectively to generate a weighted sum of absolute values, a weighted sum of vertical coordinate values and a weighted sum of horizontal coordinate values to generate the estimated data amount accordingly.

4. The video encoding apparatus according to claim 1, wherein, for each intra-prediction and motion compensation mode, the data amount estimating circuit further calculates a quantity of bypass data and a quantity of non-bypass data of corresponding metadata to accordingly generate an estimated metadata amount for use in generating the estimated data amount value.

5. The video encoding apparatus according to claim 1, further comprising:
an inverse quantization circuit, performing inverse quantization on each set of transformed and quantized residual data to generate an inverse quantized result;
wherein, the controller further comprises:
a distortion estimating circuit, calculating, for each intra-prediction and motion compensation mode, a difference between the inverse quantized result and the transformed matrix as an estimated distortion amount;
wherein, the evaluating circuit selects the best mode further according to the estimated distortion amounts of the respective intra-prediction and motion compensation modes.

6. The video encoding apparatus according to claim 5, wherein the distortion estimating circuit calculates a most-significant-bit difference between the transformed matrix and the inverse quantized result and omits a least-significant-bit difference between the two.

7. A video encoding method, comprising:
a) adopting a plurality of intra-prediction and motion compensation modes for an image block to be encoded to determine a plurality of reference blocks;
b) generating a plurality of sets of corresponding residual data according to the image block to be encoded and the plurality of reference blocks;
c) performing discrete cosine transform (DCT) on each set of residual data to generate a transformed matrix;
d) performing quantization on each transformed matrix to generate a set of transformed and quantized residual data;
e) calculating, for each set of transformed and quantized residual data, a sum of absolute values of non-zero elements therein and a sum of coordinate values of these non-zero elements relative to a reference point;
f) generating an estimated data amount according to the sum of the absolute values and the sum of the coordinate values of the corresponding transformed and quantized residual data of each intra-prediction and motion compensation mode; and
g) selecting a best mode from the plurality of intra-prediction and motion compensation modes according to the plurality of estimated data amounts.

8. The video encoding method according to claim 7, wherein step (f), of each set of transformed and quantized residual data, comprises:
assigning predetermined weightings to the sum of the absolute values and the sum of the coordinate values to generate a weighted sum of the absolute values and a weighted sum of the coordinate values to generate the estimated data amount accordingly.

9. The video encoding method according to claim 7, wherein:
step (e) comprises calculating, for each set of transformed and quantized residual data, a sum of vertical coordinate values and a sum of horizontal coordinate values of non-zero elements therein; and
step (f) comprises assigning predetermined weightings to the sum of the absolute values, the sum of the vertical coordinate values and the sum of the horizontal coordinate values to generate a weighted sum of absolute values, a weighted sum of vertical coordinate values and a weighted sum of horizontal coordinate values respectively to generate the estimated data amount accordingly.

10. The video encoding method according to claim 7, further comprising:
calculating, for each intra-prediction and motion compensation mode, a quantity of bypass data and a quantity of non-bypass data of corresponding metadata to accordingly generate an estimated metadata amount;
wherein, step (f) generates the estimated data amount for for use in generating the estimated data amount.

11. The video encoding method according to claim 7, further comprising:
performing inverse quantization on each set of transformed residual data to generate an inverse quantized result; and
calculating, for each intra-prediction and motion compensation mode, a difference between the inverse quantized result and the transformed matrix as an estimated distortion amount;
wherein, step (g) selects the best mode further according to the estimated distortion amounts of the respective intra-prediction and motion compensation modes.

12. The video encoding method according to claim 11, wherein a most-significant-bit difference between the transformed matrix and the inverse quantized result is calculated and a least-significant-bit difference between the two is omitted.

13. A video encoding method, comprising:
a) performing discrete cosine transform (DCT) on image data to generate a transformed matrix;
b) performing quantization on the transformed matrix to generate transformed and quantized data;
c) performing inverse quantization on the transformed and quantized data to generate an inverse quantized result; and
d) determining an estimated distortion amount according to a difference between the transformed matrix and the inverse quantized result.

14. The video encoding method according to claim 13, wherein step (d) comprises calculating a most-significant-bit difference between the transformed matrix and the inverse quantized result and omitting a least-significant-bit difference between the two.
